(19) United States
(12) Patent Application Publication
(10) Pub. No.: US 2015/0100475 A1
(43) Pub. Date: Apr. 9, 2015

(54) SYSTEM AND METHOD FOR MANAGING PAYDAY ACCOUNTS OVER A MOBILE NETWORK

(71) Applicant: DOLLAR FINANCIAL GROUP, INC., Berwyn, PA (US)

(72) Inventors: Bruce David CUMMINGS, Sooke (CA); Nicholas Bosch, Glenside, PA (US); Michael Coury, Phoenixville, PA (US)

(73) Assignee: DOLLAR FINANCIAL GROUP, INC., Berwyn, PA (US)

(21) Appl. No.: 14/510,622

(22) Filed: Oct. 9, 2014

Related U.S. Application Data
(60) Provisional application No. 61/888,695, filed on Oct. 9, 2013.

(51) Int. Cl. G06Q 20/10; G06Q 20/32; G06Q 20/40

(52) U.S. Cl. CPC G06Q 20/108; G06Q 20/4016; G06Q 20/322; G06Q 40/025
USPC 705/38; 705/42

(57) ABSTRACT

Exemplary systems and methods of the disclosure are directed to managing payday accounts over a mobile network. The system includes at least one mobile computing device and at least one host computing device. The mobile computing device is associated with a customer and configured to retrieve customer account information from the host computing device over the network. The mobile computing device generates a customized payday product menu based on the customer account information. The customer account information indicates a status of active payday accounts for the customer or the customer's eligibility for opening new payday accounts.

### FIELD

The disclosure is related to a mobile banking system and particularly a mobile banking system for managing short to intermediate term loan accounts including payday loan accounts, check cashing accounts and other financial transactions,

### BACKGROUND

Technological advances in smart phone technology and other portable processing devices, such as tablet computers have led to the development of platforms that provide the capability to conduct financial transactions remotely. Mobile banking technology allows consumers to remotely access accounts registered with a financial institution in order to check account balances, transfer funds between accounts, send money to third parties, make payments on loans and credit accounts.

Currently some financial institutions have developed vehicles to allow users to apply for loans and/or credit accounts remotely over a data communication network, such as a wide area network including the Internet. These vehicles are generally associated with long-term loans and credit, which have a repayment schedule that extends for a period longer than six months, and short-term loans, e.g., loans with a repayment schedule extending between, 14 days to 31 days, 1-3 months, 3-6 months, or other suitable term as desired. Furthermore, short-term loans are unsecured and are subject to underwriting criteria that is specified by the lender. Mobile banking processes should provide a secure and efficient remote/online process allowing consumers to apply for short-term loans and financial institutions to competently review loan applications to mitigate fraud.

### SUMMARY

An exemplary system for managing payday accounts over a mobile network is disclosed. The system comprises a mobile computing device associated with a customer and configured to retrieve customer account information from a host computing device over the network and generate a customized payday product menu based on the customer account information, the customer account information indicating a status of active payday accounts for the customer or the customer's eligibility for opening new payday accounts.

An exemplary system for managing payday accounts over a mobile network is disclosed. The system comprising: a host computing device configured to: retrieve customer account information from a database; determine at least one of a status of an active payday account or whether the customer is eligible for opening a new payday account based on the customer account information; and communicate the customer account information including results of the determination to a mobile computing device over the network.

An exemplary mobile banking method for approving a check cashing transaction over a mobile network is disclosed. The method comprises receiving transaction data including at least customer account information; performing an electronic risk assessment based on the transaction data and check issuer information; sending the transaction data to a queue for performing a manual risk assessment; computing terms of the check cashing transaction based on results of at least one of the electronic and manual risk assessments; and forwarding results of at least one of the electronic and manual risk assessment and the computed transaction terms to a mobile device on the network.

An exemplary mobile banking method for approving a payday loan application over a mobile network is disclosed. The method comprising: receiving, at a server, application data and customer information; performing an electronic risk assessment based on the received data and information; sending the transaction data to a queue for performing a manual risk assessment; computing terms of the loan based on results of at least one of the electronic and manual risk assessments; and forwarding results of at least one of the electronic and manual risk assessment and the computed loan terms to a mobile device on the network.

### DESCRIPTION OF THE DRAWINGS

In the following the disclosure will be described in greater detail by means of exemplary embodiments with reference to the accompanying drawings, in which:

FIG. 1 illustrates an overview of a mobile banking system in accordance with an exemplary embodiment of the present disclosure.

FIG. 2 illustrates a process for downloading and authorizing a mobile banking application in accordance with an exemplary embodiment of the present disclosure.

FIG. 3A illustrates a process for customer verification and account access in accordance with an exemplary embodiment of the present disclosure.

FIG. 3B illustrates a user authentication sequence in accordance with an exemplary embodiment of the present disclosure.

FIG. 3C illustrates an account balance acquisition sequence in accordance with an exemplary embodiment of the present disclosure.

FIG. 4 illustrates a process for approving for a payday loan account in accordance with an exemplary embodiment of the present disclosure.

FIG. 5 illustrates a process for approving a check cashing transaction in accordance with an exemplary embodiment of the present disclosure.

### DETAILED DESCRIPTION

Exemplary embodiments of the present disclosure are directed to a system and method for providing a mobile application for customers to manage and apply for payday accounts. These payday accounts can include payday loans that are designed for customers that need money prior to their next payday or the date upon which wages are received from their employer. The exemplary embodiments disclosed herein provide a fast and trouble-free manner for new and existing customers to apply for, receive, and access funds for a payday loan using an Automatic Teller Machine (ATM) or credit card.

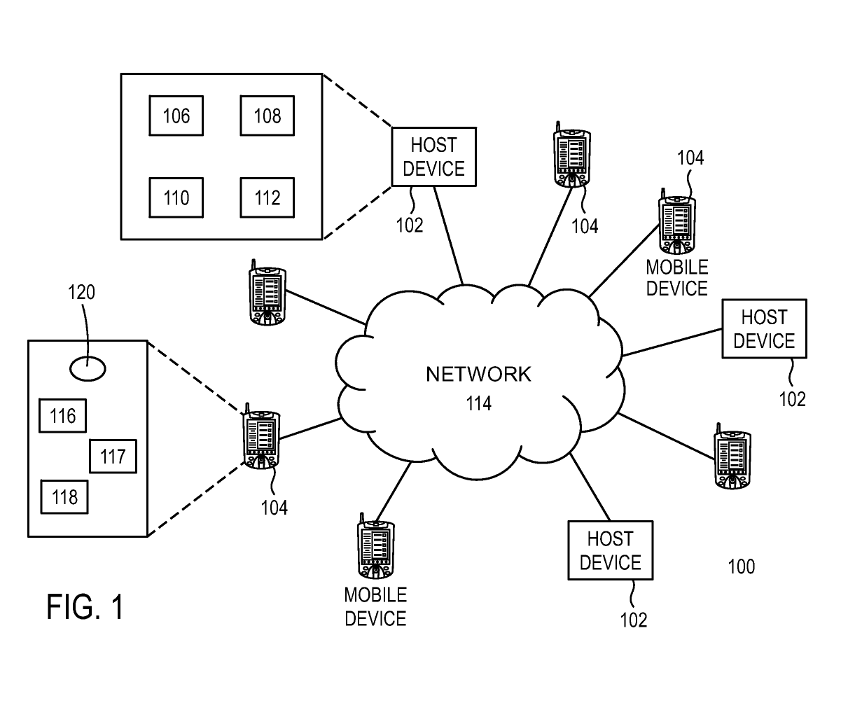

FIG. 1 illustrates an overview of a mobile banking system in accordance with an exemplary embodiment of the present disclosure.

As shown in FIG. 1, the system includes at least one host computing device 102 such as computer or computer system that includes at least one processor or processing device 106, memory 108, a communications interface 110, and a user interface 112. The system can also include any number of mobile computing devices 104, such as a handheld computing device, which can include a display screen with touch input and/or a miniature keyboard. The host computing device 102 and the mobile computing devices 104 can be configured to communicate over a network 114, such as a network having a wireless or Internet protocol.

The processor 106 of the host computing device 102 can include any of known processing devices suitable for operation with a client or server computer system that provides for the management of customer mobile banking accounts and processing customer requests.

It will be apparent to persons having skill in the relevant art that methods and processes disclosed herein can be implemented in the computing system using hardware, software, firmware, non-transitory computer readable media having instructions stored therein, or a combination thereof, and can be implemented in more than one computing systems or other processing systems. It will be further apparent to persons having skill in the relevant art that the configuration of the computing system as illustrated in FIGS. 1-5 are provided as illustrations, and other configurations and systems for performing the functions disclosed can be appropriate.

The host computing device 102 can include a processing unit 106. The processing unit 106 can include a single processor or a plurality of processor, each of which can have one or more processor cores. The processing unit 106 can be a general purpose processing unit or a special purpose processing unit, such as a general purpose processing unit programmed for performing a specific purpose, such as executing a mobile banking application that performs balance inquiries, manages transaction histories, and processes payday loan applications. The processing unit 106 may be configured to connect to a communications infrastructure for communication with additional components of the computing system.

The communications infrastructure can include a bus, message queue, network, multi-core message-passing scheme, a combination thereof, or any other suitable type or configuration of communications infrastructure as will be apparent to persons having skill in the relevant art. The host computing device 102 may further include a user interface 112. The user interface 112 can be configured to control a display device, which can be connected to the computing system physically (e.g., via a cable, such as a VGA, DVI, or HDMI cable) or wirelessly (e.g., via Bluetooth, or any other suitable non-wired transmission scheme as desired). The display device can include a display interface such as a video card, video adapter, graphics card, display card, graphics board, display adapter, graphics adapter, video controller, graphics controller, etc., and can be integrated into the computing system or can be removable.

The display device may be configured to display information (e.g., data, graphics, output from an application program, or any other suitable display platform) transmitted to the display device via the display unit. Suitable types of display devices for use as the display device will be apparent to persons having skill in the relevant art and can include a liquid crystal display (LCD), light-emitting diode (LED) display, thin film transistor (TFT) LCD, capacitive touch display, or other suitable display technology as desired. The user interface 112 can also include a keyboard, mouse, touchpad, touchscreen, stylus, or any other suitable input device as desired.

The host computing device 102 can further include a memory unit 108. The memory unit 108 may be any type of memory suitable for the storage of data and performing of the functions disclosed herein, such as a hard disk drive, floppy disk drive, magnetic tape drive, optical disk drive, solid state drive, or other suitable non-transitory computer readable medium. In some embodiments, the memory unit 108 can be removable storage (e.g., flash memory, a compact disc, digital versatile disc, Blu-ray disc, or other suitable storage device as desired) or a combination of non-removable and removable storage. In an exemplary embodiment, the memory unit 108 can be external to the computing system and accessed via a network by a communications interface, discussed in more detail below, such as cloud storage. The memory unit 108 may include random access memory (RAM), read-only memory (ROM), or a combination thereof. Suitable types and configurations of the memory unit will be apparent to persons having skill in the relevant art.

The communications interface 110 can be configured to allow software and data to be transmitted between the host computing device 102 and external networks 114 and devices (e.g., mobile computing devices 104). The communications interface may be a modem, network interface card (e.g., an Ethernet card), a communications port, a Personal Computer Memory Card International Association (PCMCIA) card, or other type of communications interface suitable for performing the functions disclosed herein as will be apparent to persons having skill in the relevant art. Software and data transmitted to or from the computing system may be in the form of signals, which may be electrical, electronic, electromagnetic, or optical, etc. The signals may travel via a communications path, which may be configured to carry the signals physically or wirelessly via a network. The communications path can carry signals from the communications interface 110 to a network 114 such as a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

The communications interface 110 can be further configured to connect the host computing device 102 with a plurality of input devices, such as mobile computing devices 104, which can enable a user of the computing system to control the system. In some instances, the communications interface 110 can include multiple interfaces or connections, for connecting to a variety of external devices or networks. For example, the communications interface 110 can include a plurality of universal serial bus (USB) connectors, an Ethernet connector, audio connectors, video connectors, or other suitable connecting or coupling interface as desired. Suitable types of input devices that can be used with the computing system 100 for providing input will be apparent to persons having skill in the relevant art and can include a keyboard, mouse, touch screen, tablet, click wheel, trackball, microphone, camera, etc.

The mobile computing device 104 can include a handheld computing device, such as mobile phone, smart phone, personal data assistant (PDA), or other suitable device having a processor 116 configured with an operating system (OS), which can be further configured with software code to run any number of application software for providing mobile banking payday services such as payday account balance inquiries, transaction history processing, and payday loan application processing. The mobile computing device can also include memory 117 for storing configuration data, customer data, software code, usage data, or any other suitable data and/or information as desired. The mobile computing device 104 can be equipped with a communications interface 118 for Wi-Fi, Bluetooth, and GPS capabilities that can allow connections to the Internet and other Bluetooth-capable devices. A camera 120 for generating still or video image files can also be included in the mobile computing device 104 configuration and/or structure. The mobile computing device 104 can also include a stable battery power source such as a lithium battery. The signals generated by the mobile computing device 104 can travel via a communications path, which may be configured to carry the signals physically or wirelessly via a network 114 (e.g., mobile network). The communications path can carry signals from the communications interface 118 to a network such as a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art.

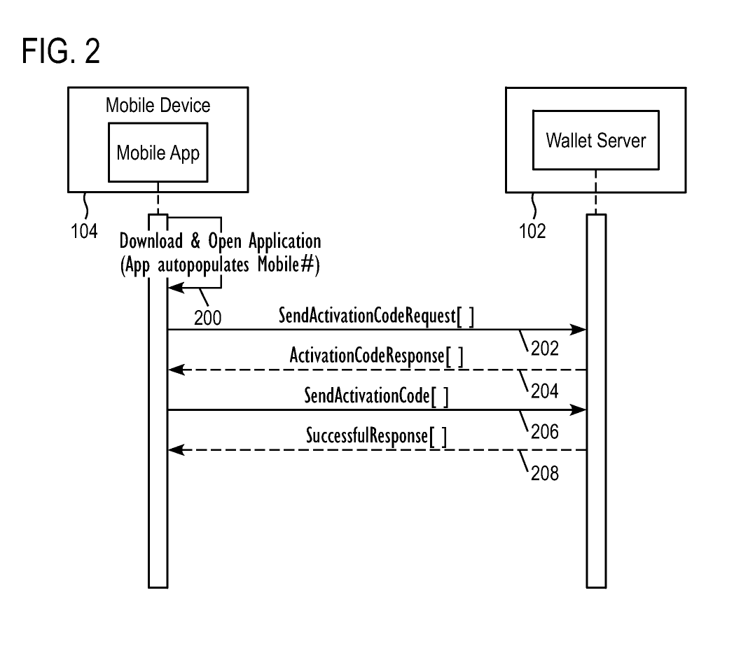

FIG. 2 illustrates a process for downloading and authorizing a mobile banking application in accordance with an exemplary embodiment of the present disclosure.

To access the features of the mobile banking application, the application should be downloaded to the mobile computing device 104 (200). Once downloaded from a host computing device 102 configured as an application server, the mobile banking application can be activated on the mobile computing device. Upon activation, the mobile banking application retrieves a customer phone number from a memory location (e.g., Subscriber Identification Module (SIM) card) of the mobile computing device. The mobile banking application includes the phone number in an activation code request that is sent to a host computing device 102 configured as a Wallet Server (202). The Wallet Server responds to the request by sending an activation code to the mobile computing device via a Short Message Service (SMS) message (e.g., text message), for example, or other suitable communication protocol as desired (204). The authorization code is provided to the mobile banking application so that an activation code is generated. The mobile computing device 104 sends the activation code to the Wallet server 102 for verification (206). Once verified at the Wallet Server 102, an authorization confirmation is returned to the mobile computing device 104 (208). When authorization confirmation is received, the mobile banking application will control the mobile computing device 104 to generate any combination of a visual and/or audible notification to the customer. The notification is an indication that the mobile computing device is suitably configured to communicate with the Wallet Server 102, and other computing devices as needed, via the mobile banking application.

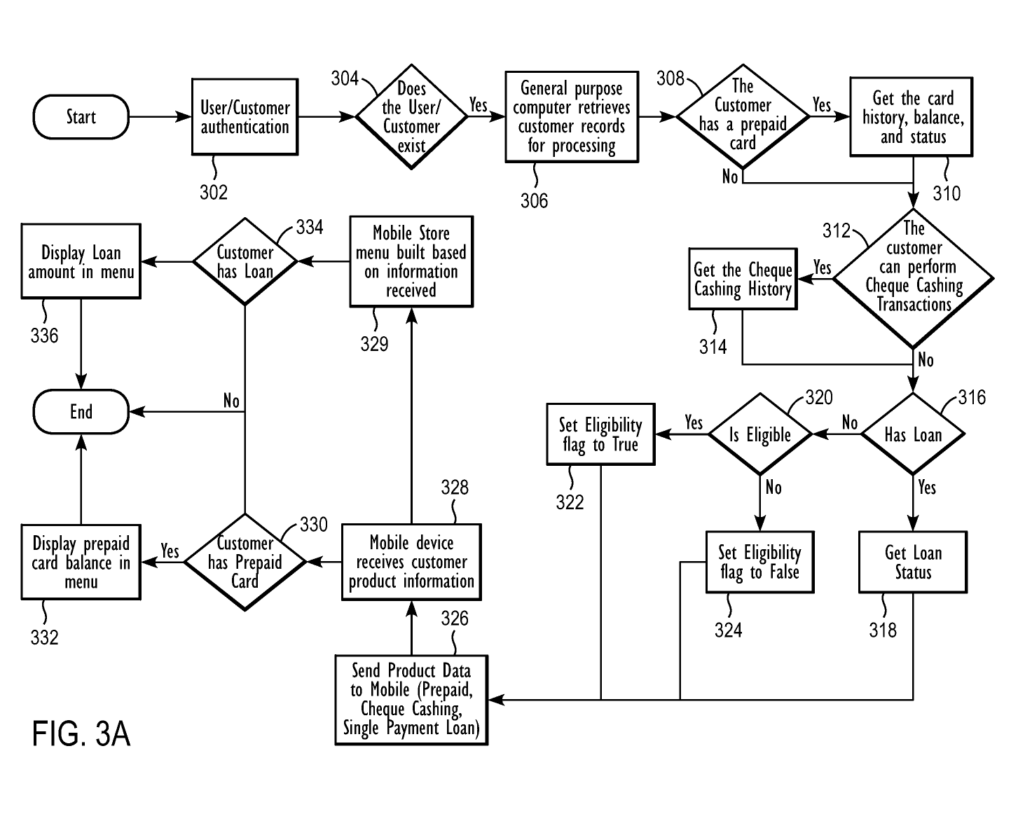

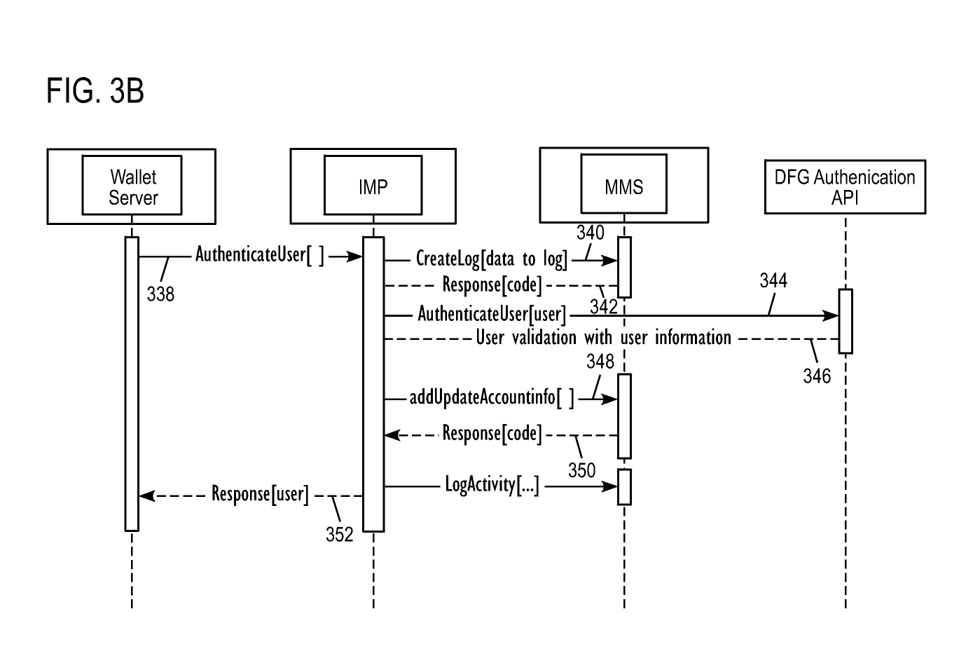

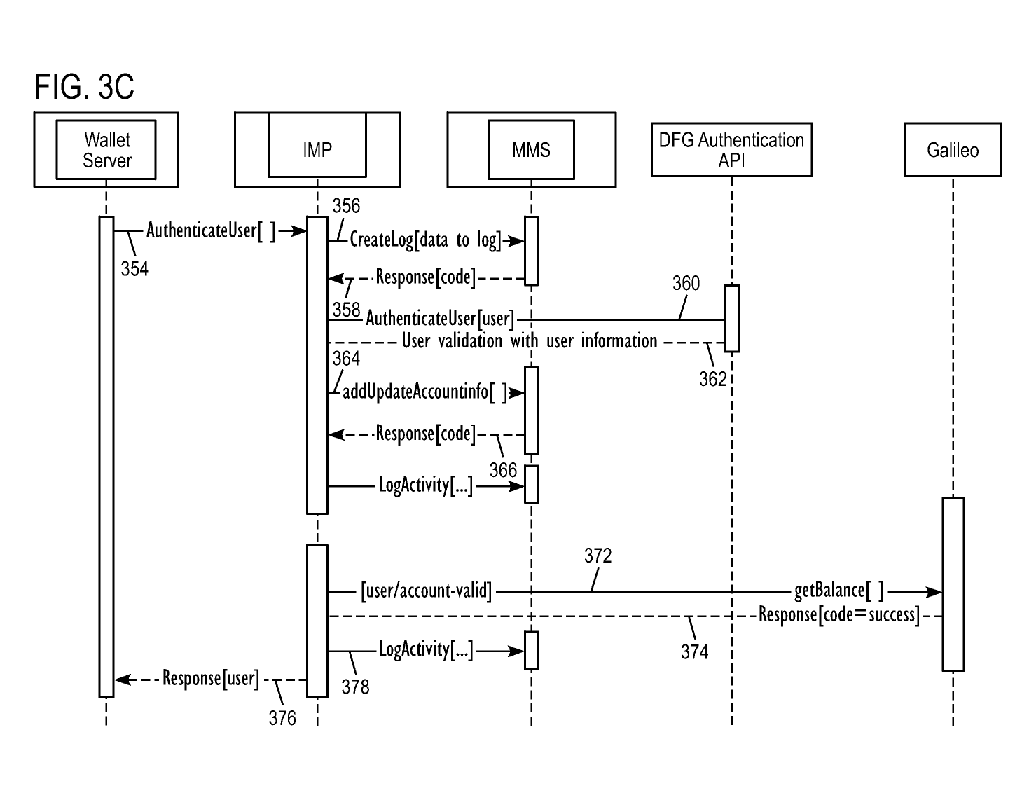

FIG. 3A illustrates a process for customer verification and account access in accordance with an exemplary embodiment of the present disclosure.

Upon launching the mobile banking application on the mobile computing device following successful authorization, the customer can be prompted to enter a username, password, pin code, user identification, or any other suitable manner of verifying the identity and authenticity of a customer (302).

The mobile computing device 104 sends the identification information to the Wallet Server where the user's identification is verified against entries stored in a database to determine if the customer exists (304). For example, the user's identification information is compared against data in databases including LexisNexis® Certified ID, LexisNexis® Bridger Insight, LexisNexis® Person Search, Targus Phone Verification (e.g., for home and mobile phones), Google (e.g., name search), and any other suitable database or identification verification service as desired. Verification of the user's identification confirms that the user's customer profile includes accurate information, and confirms the transactions or activities the user is authorized to perform. If the customer is identified as a valid user then the mobile computing device 104 is provided access to the customer's banking records stored in a database (306). On the other hand, if the user's attempts at logging in to the mobile banking application fail the user will be denied access to any banking records until the appropriate identification information is provided.

When downloading the user's account information the mobile banking application determines the menu items that are to be presented to the customer. For example, based on at least one of the number and type of active payday accounts, the customer's transaction history, and/or other customer banking information and/or banking habits, or any other suitable metric as desired, the mobile banking application can determine the information suitable for populating the menu presented to the customer.

In an exemplary embodiment, during retrieval of the customer's information from the database, the mobile banking application determines whether the customer has a prepaid card (308). If the customer does have a prepaid card, then the transaction history of the card, the card balance, and the card status are retrieved from the database (310). Using this information, the Wallet Server 102 can determine whether the customer is authorized to perform check cashing transactions (312). On the other hand, if the customer does not have a prepaid card, then the processing determines whether the customer can engage in check cashing services (312). If the customer is authorized to perform check cashing transactions then the mobile banking application retrieves the check cashing history from the Wallet Server 102 (314), and next determines if the customer has a payday loan account (316). If the customer is not authorized to perform check cashing transactions, the process proceeds to determining whether the customer has a loan (316).

If the system determines that the customer has a loan, a status of the payday loan account is retrieved from the database (318). Information regarding the loan status, the prepaid card, and the check cashing history, where applicable, are presented to the user. On the other hand, if the customer does not have a payday loan account then it is determined if the customer is eligible for obtaining a payday loan account (320). If the determination results in a “Yes” then an eligibility flag in the mobile banking application is set to “True” (322). On the other hand, if the loan eligibility information results in a “No” then the eligibility flag is set to “False” (324). In the event, the customer is eligible for obtaining a payday loan account, all retrieved customer information is packaged and sent to the mobile computing device 104 for generating a customized menu (326).

According to an exemplary embodiment disclosed herein, the payday loan can include a short-term unsecured loan (e.g., cash advance) that is repaid by the borrower upon receipt of the next pay check following approval and acceptance of the loan. In another exemplary embodiment, the payday loan can include a multi-payment loan where the repayment schedule spans 3 to 6 months. As in the short-term loan vehicle, repayment for the multi-payment loan can occur at each instance a pay check is received by the borrower, or at another agreed-upon schedule as desired, over the term of the loan. In yet another exemplary embodiment of the present disclosure, the payday loan can include an installment loan in which the repayment schedule spans 6 to 12 months or more. Each installment of the repayment schedule can occur based on the borrower's payday schedule, or upon another agreed-upon schedule as desired.

Based on the retrieved information (328) the mobile banking application, generates a customized menu that is presented to the customer on a display of the mobile computing device 104 (329). It should be appreciated by one of skill in the art that the menu can be a single menu or a plurality of nested menus providing respective account information. For example, if the customer has a prepaid card (330) then at least the card balance, card history, and card status are presented to the user on the display (332). If the customer has a payday loan account (334) then the loan status, loan balance, and loan transaction history can be presented to the customer on the display (336). On the other hand, if the user does not have any payday accounts, such as an ATM card, a prepaid card, or a loan, then the menu displayed to the customer includes selection options for applying for a payday loan account and/or obtaining an ATM or pre-paid card for loan and/or check-cashing services.

FIG. 3B illustrates a user authentication sequence in accordance with an exemplary embodiment of the present disclosure.

As shown in FIG. 3B, the host computing device 102 (Wallet Server) triggers an AuthenticateUser transaction with the IMP (338). The IMP logs the request with the MMS (340), and the MMS sends a response to the IMP when the log of the request is complete (342). The IMP makes an AuthenticateUser call to an Authentication API (344). The API responds to the call with a user authentication messages that includes user information (346). The user account information received from the API is sent by the IMP to the MMS to create or update a customer account (348). The MMS sends a response to the IMP when the account is generated or updated (350). The IMP sends a message to the Wallet Server 102 in response to the AuthenticateUser transaction message (352). Following authentication, all activity associated with the customer account is logged in the MMS (354).

FIG. 3C illustrates an account balance acquisition sequence in accordance with an exemplary embodiment of the present disclosure.

As shown in FIG. 3C, the host computing device 102 (Wallet Server) triggers an AuthenticateUser transaction with the IMP (356). The IMP logs the request with the MMS (358), and the MMS sends a response to the IMP when the log of the request is complete (360). The IMP makes an AuthenticateUser call to an Authentication API (362). The API responds to the call with a user authentication messages that includes user information (364). The user account information received from the API is sent by the IMP to the MMS to create or update a customer account (366). The MMS sends a response to the IMP when the account is generated or updated (368). The IMP sends a message to the Wallet Server 102 in response to the AuthenticateUser transaction message (370). The IMP sends the account information to the database to retrieve a customer account balance (372). The database sends the requested information to the IMP (374). The IMP sends the response to the Wallet Server 102 (376). Following authentication, all activity associated with the customer account is logged in the MMS (378).

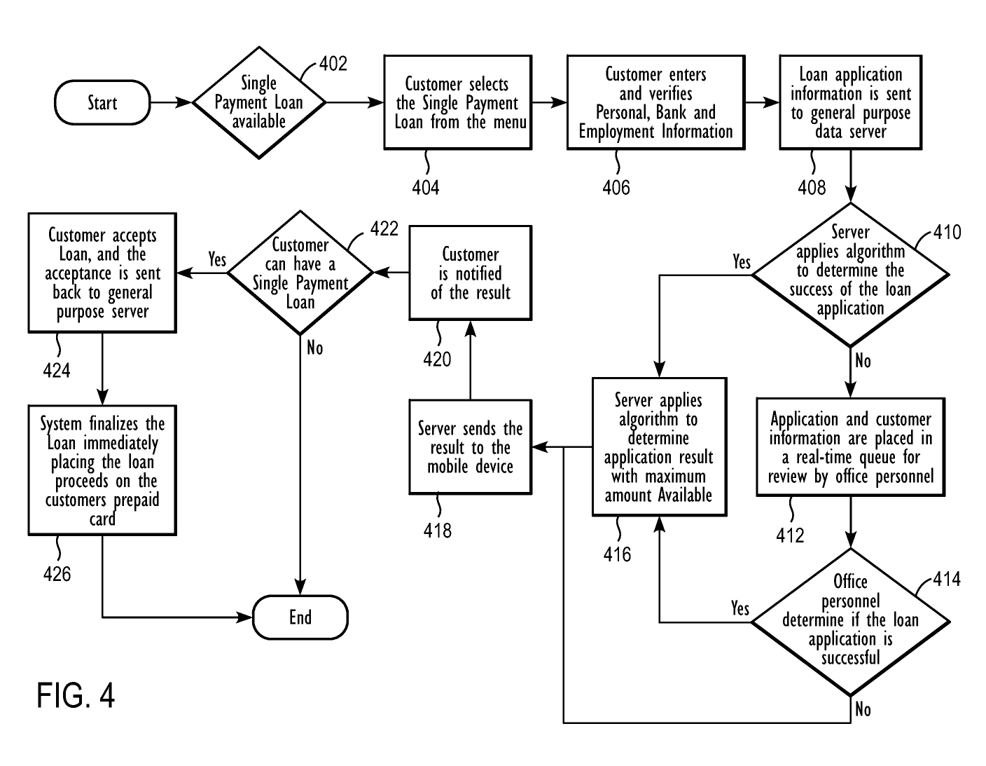

FIG. 4 illustrates a process for approving a payday loan application in accordance with an exemplary embodiment of the present disclosure.

As shown in FIG. 4, to initiate the loan application process a menu of at least one payday loan vehicle is presented to the customer via the user interface 112 of the mobile computing device 104 (402). The customer selects a payday loan vehicle from the menu (404) and is thereafter prompted on one or a number of screens to provide (e.g., input) personal, banking, and employment information (406). It should be understood by the skilled artisan that the information provided when applying for a payday loan account is in no way limited to the above-listed categories, but may include any information or data that is relevant for verifying loan eligibility under the appropriate federal and/or state provisions. The information entered by the user is sent to a host computing device 102, such as an Underwriting Server (408). At the Underwriting Server the data is processed electronically through an algorithm executed by the processing unit 106 of the host computing device 102, to assess the customer's risk concerning loan repayment (410). In an exemplary embodiment, the host computing device obtains a connection or access to any of a number of databases used to verify the identity of the customer based on the information entered. For example, as already discussed, the user's identification information is compared against data in databases including LexisNexis® Certified ID, LexisNexis® Bridger Insight, LexisNexis® Person Search, Targus Phone Verification (e.g., for home and mobile phones), Google (e.g., name search), and any other suitable database or identification verification service as desired.

In some instances, the application and customer information is stored and placed in a queue for real-time evaluation or manual review by authorized personnel for compliance and loss prevention/fraud (412). For example, the risk assessment can be a candidate for manual review because of the amount of the loan, availability of obtaining or lack of information on the customer, or because of other factors or conditions as desired. In another exemplary embodiment, if the risk-level calculated by the Underwriting Server is above, below, or within a specified range of a predetermined threshold as desired, then the mobile transaction and customer information is placed into a real-time queue for manual review by the authorized personnel (414). The manual review is performed to ensure appropriate customer identification for check confirmation, fraud prevention, and potential collections activity. For example, the manual review can include at least any one or more of the following:
comparing the signature on a check against a known exemplar of the signature stored in a database;
comparing a check against known check types from the issuing bank;
comparing account numbers on a check to a database of known fraudulent or closed accounts;
analyzing a check for signs of counterfeiting or alteration;
determining whether the check number is low or non-sequential;
determining whether the account associated with a check has sufficient funds; and
comparing a check against known methods of altering, counterfeiting, or forging checks.

Moreover, the manual review can ensure that the loan, if issued, complies with anti-money laundering, Know Your Customer (KYC), and other suitable regulatory requirements as needed or desired. Once the customer's risk is electronically and/or manually assessed the risk assessment is used to determine a suitable loan amount is determined (416). According to exemplary embodiments of the present disclosure, the loan amount can be computed in any of a number of formats or values. For example, the approved loan amount can include a maximum allowable loan value, identify a range of loan values between a minimum and maximum loan value, and/or identify a specific approved loan amount. The computed values represent a loan determined based on the customer's assessed risk. On the other hand, the results of the risk assessment could determine that the customer is not eligible for a loan.

The results of the loan application review can be sent to the mobile banking application of the mobile computing device, which is commanded to generate via a visual and/or auditory message for user notification (418). These results can include at least an approved loan amount, an approved interest rate, an approved transaction fee, a declined message, and any other relevant loan or customer information as desired (420). If the customer's loan application is approved, the customer is prompted to review and accept or decline the loan terms (422, 424). Following notification, the approval status of the loan application expires after a specified time elapses, e.g., 48 hours, or any other suitable time value specified by the loan administrator. If, however, the customer accepts the terms of the loan, then the loan is immediately finalized and the loan proceeds are placed on the customer's prepaid card less any transaction fees (426). If the loan application is declined and/or the user does not accept the loan within some specified time frame, then the mobile application terminates the session and returns to the product information menu.

In accordance with an exemplary embodiment of the present disclosure the loan proceeds and/or funds distributed to the user can take the form of government issued currencies and/or virtual currencies. The government issued currencies can include any of banknotes, coins, and money (e.g., paper) that has an associated or designated value and is used as a medium of exchange for goods and/or services in an economic transaction. The virtual currencies can include any type of digital currency that is used as a medium of exchange for goods and/or services in a computer or online network.

Furthermore, virtual currencies can include a type of digital currency that is used and controlled by a single financial institution and its customers, such as a token or coupon, or a type of digital currency that is widely used over a computer network and has no single administrator or repository, such as Bitcoin. Bitcoin can be derived or obtained by users through their own “mining” or manufacturing efforts via open-source computer code.

Virtual currencies can provide a secure means for issuing loan proceeds in accordance with an exemplary embodiment of the present disclosure. Bitcoin, for example, is a cryptocurrency in which the exchange between computing devices involves public-key cryptography. The exchange relies on the creation of an interlocking pair of encryption keys including a public key that is freely distributed and a private key that is not disseminated publicly. The public key serves as an address to which a Bitcoin value can be sent. The private key allows a sending or paying party to sign over any part or full value of Bitcoins associated with a respective address. The public key verifies that the sender associated with the private key signed the transaction. The results of a transaction are appended to a public ledger called a block chain. The block chain includes a complete and public record where every unit of currency is tracked from a first to present owner, which prevents fraud by guaranteeing that a buyer owns the value of Bitcoins specified in the transaction.

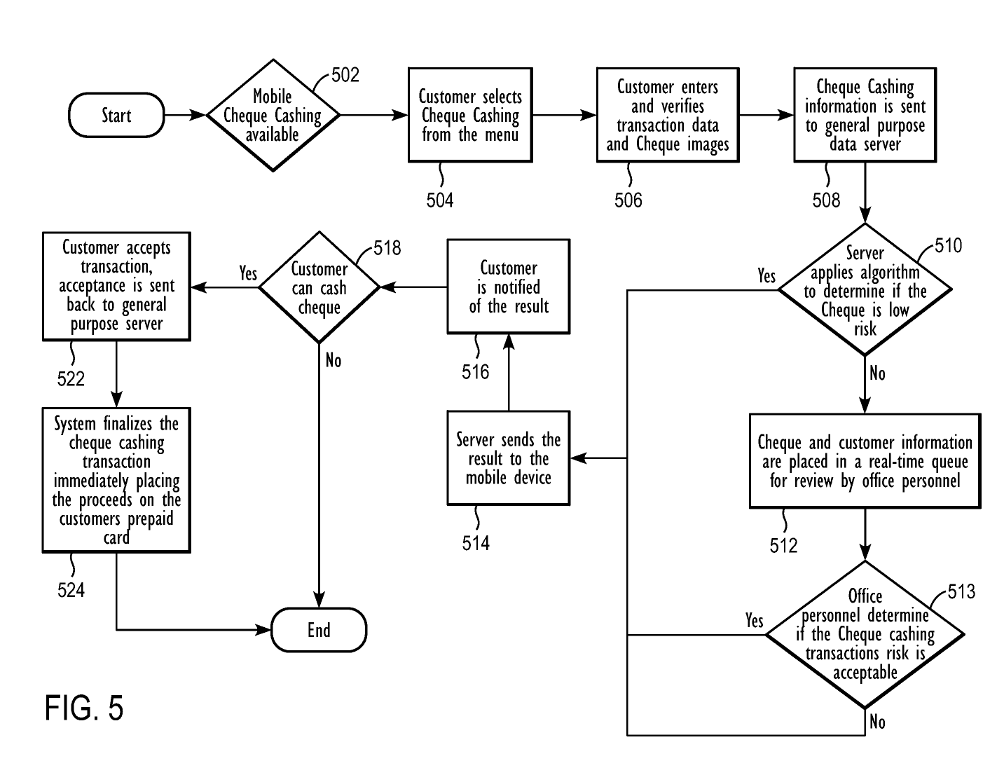

FIG. 5 illustrates a process for approving a check cashing transaction in accordance with an exemplary embodiment of the present disclosure.

If the customer is eligible for performing check cashing transactions, e.g., the customer has at least a prepaid card account and/or has been previously approved to conduct check cashing transactions, then the check cashing product appears on the main menu (502). Upon selection of the check cashing product, the customer is prompted to enter information describing the check cashing transaction along with an image of the check (504). For example, the check cashing transaction information can include a check amount, and a name, address, and telephone number of the check issuer. Moreover, the check image should include front and back views of the check with “VOID” written across the front. Alternatively, or in addition to transmission of the voided check image, the customer can mail a physical copy of the voided check to an authorized location, or present a physical copy of the voided check to an authorized merchant. In an exemplary embodiment, customers who fail to provide an image of the voided check can be prohibited from engaging in future transactions. Presentation of the voided check mitigates the risk of dual presentment of a check.

Once the information associated with the check cashing transaction is entered (506), it is forwarded to an Authorization Server for assessing the risk of the check cashing transaction (508). The Authorization Server acquires, from the database or other memory location on the network, information associated with the check issuer along with the customer's information in performing the risk assessment through an algorithm executed by the processor (510). For example, the Authorization Server can review the check using various known review systems, such as CheckReview by Cachet Financial Solutions, or other suitable verification tools as desired.

If the Authorization Server cannot determine a risk level of the check cashing transaction, then the transaction information is forwarded to a real-time queue for manual review by authorized staff (512). The authorization server may be unable to calculate a risk-assessment because of variables associated with the transaction. For example, the risk assessment can be candidate for manual review because of the amount of the check, availability of obtaining information on the check issuer, or because of other factors or conditions as desired (513). In another exemplary embodiment, if the risk-level calculated by the Authorization Server is above, below, or within a specified range of a predetermined threshold as desired, then the mobile transaction and customer information is placed into a real-time queue for manual review by the authorized staff. According to an exemplary embodiment of the present disclosure, the manual review can include at least any one or more of the review or analysis steps already discussed with respect to the process for approving a payday loan application of FIG. 4.

Based on the results of the manual and/or electronic risk assessments, the Authorization Server can compute a suitable transaction fee. The results of the risk assessment and the transaction fee are then sent to the mobile banking application of the mobile computing device 104 (514). If the check cashing transaction is approved then the user must review and accept the terms of the check cashing services and send them back to the Authorization Server. Following customer notification (516), the approval status of the check cashing transaction can be configured to expire after some elapsed time, e.g., 24 hours or any other suitable time value acceptable to the transaction administrator. If, however, the customer accepts the terms of the transaction within the specified time frame, then the check cashing transaction is immediately finalized (518, 522) and the check funds less the transaction fees are placed on the customer's prepaid card (524). If the check cashing transaction is declined and/or the user does not accept the terms of the transaction within a specified time frame, then the mobile application terminates the session and returns to the product information menu.

In accordance with an exemplary embodiment, if the check cashing transaction is approved, the customer can send an images of the check to be cashed to the Authorization Server over the network. The images can include front and back views of the check.

In accordance with exemplary embodiments disclosed herein, it should be understood by the skilled artisan that the host computing device can include one or a plurality of computers or computer systems. For example, a single host computing device can be configured to include functionality of an Application Server, Wallet Server, Authorization Server, and Underwriting Server. In another exemplary embodiment, the functions of the Application Server, Wallet Server, Authorization Server, and Underwriting Server can be spread across any number of host computing devices as desired.

In accordance with other exemplary embodiments of the present disclosure, a computer readable medium as already discussed can have program or software code stored thereon such that when in communicable contact with a processor of a host computing device or a mobile computing device causes the processor to perform any of the methods and processes described herein. For example, the computer readable medium can include a hard disk drive, floppy disk drive, magnetic tape drive, optical disk drive, solid state drive, or other suitable non-transitory computer readable storage device as desired. In some embodiments, the memory unit can be removable storage (e.g., flash memory, a compact disc, digital versatile disc, Blu-ray disc, etc.) or a combination of non-removable and removable storage. In an exemplary embodiment, the memory unit can be external to the computing system and accessed via a network by a communications interface, discussed in more detail below, such as cloud storage. The memory unit may include random access memory (RAM), read-only memory (ROM), or a combination thereof. Suitable types and configurations of the memory unit will be apparent to persons having skill in the relevant art.

Techniques consistent with the present disclosure provide, among other features, a system and method for the assessment of the runtime risk of an application or device. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A system for managing short to intermediate term loan accounts including payday loan accounts, check cashing accounts, and other financial transactions over a mobile network, comprising:
a mobile computing device associated with a customer and configured to retrieve customer account information from a host computing device over the network and generate a customized payday product menu based on the customer account information, the customer account information indicating a status of active payday accounts for the customer or the customer's eligibility for opening new payday accounts.

2. A system for managing payday accounts over a mobile network, comprising:
a host computing device configured to:
retrieve customer account information from a database;
determine at least one of a status of an active payday account or whether the customer is eligible for opening a new payday account based on the customer account information; and
communicate the customer account information including results of the determination to a mobile computing device over the network.

3. A mobile banking method for approving a check cashing transaction over a mobile network, comprising:
receiving transaction data including at least customer account information;
performing an electronic risk assessment based on the transaction data and check issuer information;
sending the transaction data to a queue for performing a manual risk assessment; computing terms of the check cashing transaction based on results of at least one of the electronic and manual risk assessments; and
forwarding results of at least one of the electronic and manual risk assessment and the computed transaction terms to a mobile device on the network.

4. A mobile banking method for approving a payday loan application over a mobile network, comprising:
receiving, at a server, application data and customer information;
performing an electronic risk assessment based on the received data and information;
sending the transaction data to a queue for performing a manual risk assessment;
computing terms of the loan based on results of at least one of the electronic and manual risk assessments; and
forwarding results of at least one of the electronic and manual risk assessment and the computed loan terms to a mobile device on the network.

5. A computer readable medium having program or software code stored thereon such that when in communicable contact with a processor of a computer, the computer readable medium causes the computer to perform the method as recited in claim 3.

6. A computer readable medium having program or software code stored thereon such that when in communicable contact with a processor of a computer, the computer readable medium causes the computer to perform the method as recited in claim 4.
